(19) United States
(12) Patent Application Publication
(10) Pub. No.: US 2020/0315223 A1
(43) Pub. Date: Oct. 8, 2020

(54) METHOD FOR INCREASING THE ACCESSIBILITY OF HIGHER MOLECULAR WEIGHT BETA-GLUCANS

(71) Applicant: THE QUAKER OATS COMPANY, Chicago, IL (US)

(72) Inventors: Jodee Johnson, Lake in the Hills, IL (US); YiFang Chu, Glenview, IL (US); Marianne O'Shea, Chicago, IL (US)

(21) Appl. No.: 16/373,904

(22) Filed: Apr. 3, 2019

(51) Int. Cl. A23L 5/30; A23L 33/21; A23L 7/183

(52) U.S. Cl. CPC A23L 5/34; A23V 2002/00; A23L 7/183; A23L 33/21

(57) ABSTRACT

A method of increasing the accessibility of higher molecular weight beta-glucan in beta-glucan-containing products includes microwave treating kilned groats at a power and for a period of time to increase the volume of the groats from about 5% to about 80% with a resulting viscosity of the oat beta-glucan is greater than about 500 cP as measured by Rapid Visco Analyzer. The method can further include tempering the kilned groats prior to microwave treating to increase the moisture content of the groats to a range from about 15% to about 25%.

The present disclosure relates to a method for increasing the accessibility of higher molecular weight beta-glucans in beta-glucan-containing products and for increasing the viscosity of the beta-glucan.

### BACKGROUND

Beta-glucan is a viscous soluble dietary fiber component that is useful in attenuating post-prandial glycemic response and reducing cholesterol levels. It has been hypothesized that improved glycemic control and cholesterol reduction from consumption of beta-glucan may be attributed to its viscosity in the gut, where it slows the mixing of the meal with digestive enzymes, slows the rate of gastric emptying, and thereby slows glucose uptake and binds cholesterol.

The viscosity of beta-glucan is affected by its concentration (the amount in solution), its molecular weight or size, and solubility. Beta-glucans obtained from beta-glucan-containing sources have a wide range of molecular weights (weight average molecular weight) and can range from about 25 kD (kilo Daltons) to about 3000 kD. The accessibility of particular molecular weight ranges of the beta-glucan depends on the processing manner to obtain the beta-glucan.

It has been shown that that the capability of oat beta-glucan to decrease post-prandial glucose and insulin response was lower when the molecular weight or viscosity of the beta-glucan was reduced by acid hydrolysis or by a lower dose (concentration) of the oat beta-glucan. On the other hand, generally increasing the dose of the oat beta-glucan typically results in greater reduction in glycemic response in a dose-dependent manner. However, the viscosity of beta-glucan corresponds to a greater correlation to reduction of glycemic responses than does the dose of beta-glucan.

Because the viscosity of beta-glucan is more indicative of its effect and there appears to be a limit to the amount or concentration of beta-glucan that will provide an efficacious result, it would be desirable it for a given dose or amount of beta-glucan, the accessibility of higher molecular weight fractions of beta-glucan and thus, the resulting viscosity of the beta-glucan, could be increased. The inventors discovered that oat groats that have been kilned and subsequently microwave treated produce a “partially-puffed” product (puffed to a degree less than 100%) that exhibits an increase in its volume, which is believed to improve the accessibility of higher molecular weight beta-glucans. They also discovered that the beta-glucan from microwave treated oat groats exhibited an increase in the accessibility of higher molecular weight beta-glucan and viscosity. Advantageously, the increase in the accessibility of higher molecular weight beta-glucan and viscosity are achieved without affecting the feel, look, and smell of the treated oat groats as compared to oat groats that have not been treated with a microwave.

### SUMMARY

According to one aspect of the disclosure, a method is provided to increase the accessibility of higher molecular weight beta-glucan and thus, the resulting viscosity of the beta-glucan. The beta-glucan can be from any suitable accessible source that contains beta-glucan. Typically, the beta-glucan can be obtained from oat, barley, and mixtures thereof. For ease of description, readability, and understanding the method will be described in connection with oats, although one of skill will appreciate that the method applies to other sources of beta-glucan.

Generally, the method includes providing oat groats, kilning the oat groats and subsequently microwaving the oat groats at a power level and for a period of time to increase the volume of the groats by an amount from about 5% to about 50% and such that the beta-glucan has a viscosity greater than about 500 cP (Rapid Visco Analyzer, “RVA”). Advantageously, the method increases the accessibility of higher molecular beta-glucan, therefore increasing the measured molecular weight by about 20% to about 80% In this regard, the average molecular weight of the beta-glucan in the groats that are processed according to the method shown and described in accordance with the described methods is at least 600 kDa (kilo Daltons (kDa) and ranges from about 600 kDa to about 3,000 kDa.

In another embodiment, the kilned groats are tempered before subjecting the groats to microwave treatment to increase the moisture content of the groats to a range of about 10% to about 25% by weight.

The term “average molecular weight” as used in this description refers to a or weight average molecular weight.

### BRIEF DESCRIPTION OF THE DRAWINGS

The following description accompanies the drawings, all given by way of non-limiting examples that may be useful to understand how the described process and system may be embodied.

FIG. 1 is a simplified process flow sheet according to one embodiment of the present invention,

FIG. 2 is a simplified process flow sheet according to one embodiment of the present invention.

FIG. 3 is a bar chart that shows the effect of the starting material and processing treatment on the volume of 80 grams of groats.

### DESCRIPTION

The following disclosure describes a method for increasing the accessibility of higher molecular weight beta-glucan in oat, therefore increasing the viscosity of beta-glucan in oats.

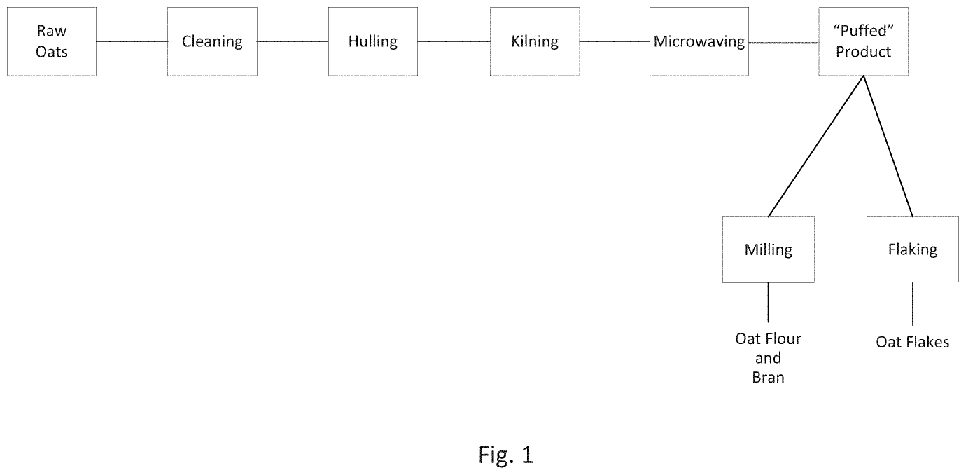

Referring to FIG. 1, a general method is shown for increasing the accessibility of higher molecular weight beta-glucan in beta-glucan-containing products. Beta-glucan-containing products processed according to the method shown in FIG. 1 exhibit an increase in viscosity of the beta-glucan as compared to products not made according to the process shown in FIG. 1.

The process begins with the receipt of raw oats 10 which are then cleaned 20 generally on the basis of the physical properties of the oats. Sieves may be used to remove contaminants on the basis of size. Thereafter, the cleaned oats are hulled to remove the tough inedible hull that covers the groat.

Hulling 30 of oats is a known process and any known process for hulling oats can be used in the present method. For example, hulling may be achieved by compressed air systems, stone hullers, and impact hullers. In an impact huller, the oats are fed through a hollow shaft of the machine to the center of a rotor that is equipped with vanes. The oats are thrown against an impact ring that is attached to the housing of the machine, the result of which is the release of the groat from the hulls.

After the oat has been hulled to release the groat, the groats are kilned 40 to inactivate the lipid hydrolyzing enzymes. In general, kilning involves the direct addition of steam followed by heating and finally cooling. The moisture content during the process typically remains below 25 wt. % and the finished kilned groats typically have a moisture content between about 8 wt. % to about 12 wt. %.

The moisture content can be determined using AACCI Approved method 44-15 (AACC International. Approved Methods of Analysis, 11th Ed. Method 44-15.02. Moisture—Air Oven Methods. Reapproved Nov. 3, 1999. AACCI: St. Paul, Minn.(http://methods.aaccnet.org/methods/44-15.pdf), the entire contents of which are incorporated by reference.

The kilned groats are then microwave 60 treated at a power level and for a period of time to increase the volume of the kilned groats by an amount from about 5% to about 75%, from about 10% to about 60%, from about 15% to about 50%, or from about 20% to about 45%. In some instances, the increase in volume is from about 20% to about 30% or from about 35% to about 50%.

Without being bound by any explanation, the inventors believe that microwaving weakens the bonds that hold the beta-glucan to other structural molecules such as cellulose microfibrils and arabinoxylans present in the cell walls so that the beta-glucan and in particular the higher molecular weight beta-glucans can more easily leave the groat. Advantageously, this volumetric expansion of the groat does not negatively affect properties such as texture, hardness, appearance (i.e., browning), or milling.

Moreover and advantageously, microwaving is effective to uniformly heat water present in the groat which can effectively provide uniform expansion of the groat without negatively affecting sensory properties, particularly as compared to conventional radiant heating.

The increase in volume of the microwave treated groats can be determined by measuring the volume of a selected weight of groats before microwaving and after microwaving. For example, 80 grams of groats before microwaving can be placed in a graduated cylinder and the volume can be visually measured; then 80 grams of groats after microwaving can be placed in a graduated cylinder and the volume can be visually measured. From the difference in volumes, the percentage increase can be determined.

The microwaving can be performed by any suitable device that can provide sufficient power to achieve the desired volume increase. The microwave generator may be a magnetron, power grid, klystron, klystrode, or gyrotron and may be operated at 915 MHz or 2450 MHz and may provide power in the range from about 1 kW to about 1000 kW. In some embodiments, the generator may operate at 915 MHz and provide power in the range of about 1 kW to about 50 kW.

The period of time during which the groats are subjected to microwaves may depend on the power provided by the microwave and the amount of groats to be treated. Typically, the period of time will range from about 1 second to about 300 seconds or from about 5 seconds to about 120 seconds, or from about 10 seconds to about 60 seconds. In some instances, the period of time is less than about 120 seconds. It has been found that in some instances, microwaving for too long, i.e., longer than about 120 seconds may adversely impact the accessibility of the higher molecular weight beta-glucan. For example, it has been observed that the viscosity of the beta-glucan reaches a peak and then exhibits a decrease with a lengthening time of microwaving.

The average molecular weight of the beta-glucan in the groats that are processed according to the method shown and described in connection with FIG. 1 is at least 600 kDa (kilo Daltons (kDa) and ranges from about 600 kDa to about 3,000 kDa or about 800 kDa to about 2,200 kDa, or about 900 kDa to about 1,800 kDa, or about 1,000 kDa. In some instances the average molecular weight of the beta-glucan is about 1,100 kDa, about 1,200 kDa, about 1,300 kDa, about 1,400 kDa, about 1,500 kDa, about 1,600 kDa, about 1,700 kDa, about 1,800 kDa, about 1,900 kDa, about 2,000 kDa, about 2,100 kDa, about 2,200 kDa, about 2,300 kDa, about 2,400 kDa, about 2,500 kDa, about 2,600 kDa, or about 2,700 kDa.

It was observed that the average molecular weight of the beta-glucan in the groats that are processed according to the method shown and described in connection with FIG. 1 was from about 20% to about 90%, or from about 30% to about 80%, or from about 40% to about 75%, or from about 45% to about 65%, or from about 50% to about 60% greater than the average molecular weight of the beta-glucan in the groats that were not processed according to the method shown and described in connection with FIG. 1.

The weight average molecular weight of the beta-glucan was determined in the following manner. Ground groat samples (Retsch ZM200 Centrifugal Mill; 0.5 mm screen) were extracted for in vitro beta-glucan analysis with the slurry comprising of 1% beta-glucan. An aliquot was centrifuged at 9000×g for 5 min, and the subsequent supernatant was used to determine beta-glucan molecular weight. The supernatant was boiled for 10 min to inactivate any endogenous beta-glucanase, cooled and syringe filtered through a 0.45 um filter prior to being injected on an Agilent 1100 HPLC, fitted with a Shodex OH pak SB-G guard column, Shodex OH pak SB-806M column and Waters ultrahydrogel linear column (10 um, 7.8×300 mm). Columns were maintained at 40° C. and eluted with 0.1M Tris buffer (pH 8.0) at 1 mL/min with post-column addition of 20 mg/L of calcofluor in 0.1M Tris buffer (pH 8.0) at 1 mL/min. The molecular weight distribution was measured using a fluorescent detector with excitation wavelength of 415 nm and emission wavelength of 445 nm.

In addition to the increase in volume exhibited by the groats, the accessibility of higher molecular weight beta-glucan present in the microwave treated groats resulted in an increased viscosity of the beta-glucan. It was observed that the accessibility of higher molecular weight beta-glucan in the microwave treated groats resulted in an increase in viscosity of beta-glucan as compared to the viscosity of beta-glucan in the groats that are not microwave treated. This increase in viscosity of beta-glucan ranges from about 10% to about 200% or from about 15% to about 160%, or from about 20% to about 120%.

The RVA viscosity ranges from about 400 cP to about 2500 cP or from about 500 cP to about 1500 cP. In some embodiments the RVA viscosity is about 400 cP, about 500 cP, about 600 cP, about 700 cP, about 800 cP, about 900 cP, about 1000 cP, about 1,100 cP, about 1,200 cP, about 1,300 cP, about 1,400 cP, about 1,500 cP, about 1,600 cP, about 1,700 cP, about 1,800 cP, about 1,900 cP, about 2,000 cP.

The viscosity of the beta-glucan was determined in the following manner. Ground groat samples (Retsch ZM200 Centrifugal Mill; 0.5 mm screen) were extracted for in vitro beta-glucan viscosity measurement using a Rapid Visco Analyzer (RVA), with the slurry comprising of 1% beta-glucan, following methodology described in Gamel, T. H., Abdel-Aal, E-S. M., Wood, P. J., Ames, N. P., and Tosh, S. M. (2012). Application of the Rapid Visco Analyzer (RVA) as an effective rheological tool for measurement of 13-glucan viscosity. Cereal Chemistry, 89(1): 52-58, the entire contents of which is incorporated by reference.

The Rapid Visco Analyzer (RVA) is a rotational viscometer that is able to continuously record the viscosity of samples under controlled temperature and shear rate conditions.

An amount of the 1% beta-glucan slurry was weighed into an RVA canister. A volume of 20 mM sodium phosphate buffer (pH 6.9) containing 10 mM NaCl, equal to 25 mL minus the moisture present in the sample, was added to the RVA canister. All the digestive enzymes (a-amylase from human saliva EC 3.2.1.1, (A1031, 5KU), pepsin from porcine gastric mucosa EC 3.4.23.1 (P7012, 2,500-3,500 U/mg of protein), and pancreatin from porcine pancreas (P7545, activity equiv. 8×USP) were added to the canister at the beginning of the run in the following amounts: 63 μL of salivary amylase (220 U/mL in 2.5 mM CaCl), 150 μL of pepsin (1,150 U/mL in 0.9% NaCl), and 300 μL of pancreatin (0.5 mg/mL in sodium phosphate buffer, pH 6.9), as used in the in vitro digestion protocol (Beer et al 1997). This combination of enzymes was denoted as onefold concentration.

The RVA (RVA-4, Newport Scientific, Warriewood, Australia) equipped with Thermocline software version 2.2 for Windows was held constant at 37° C., and mixing speed was set at 480 rpm for 10 sec followed by 2 hr at 160 rpm. Viscosity was recorded every 8 sec, and the final viscosity was noted at the end of 2 hr.

Viscosity can also be measured with a controlled strain rheometer. In this method, ground groat samples (Retsch ZM200 Centrifugal Mill; 0.5 mm screen) were extracted and an aliquot was centrifuged at 9000×g for 5 min. The subsequent supernatant was used to determine apparent viscosity. A controlled-strain rheometer (DHR-II, TA Instruments), with shear rate ramp range of 0.1-100/s at 37° C. and a cone-and-plate geometry (4°, 40 mm diameter) was used and apparent viscosity was recorded at the shear rate of 30/sec.

Subsequent to microwaving, the puffed groats can be further processed by miffing 70 or flaking 80 using known processes to provide oat flour or bran and oat flakes, respectively.

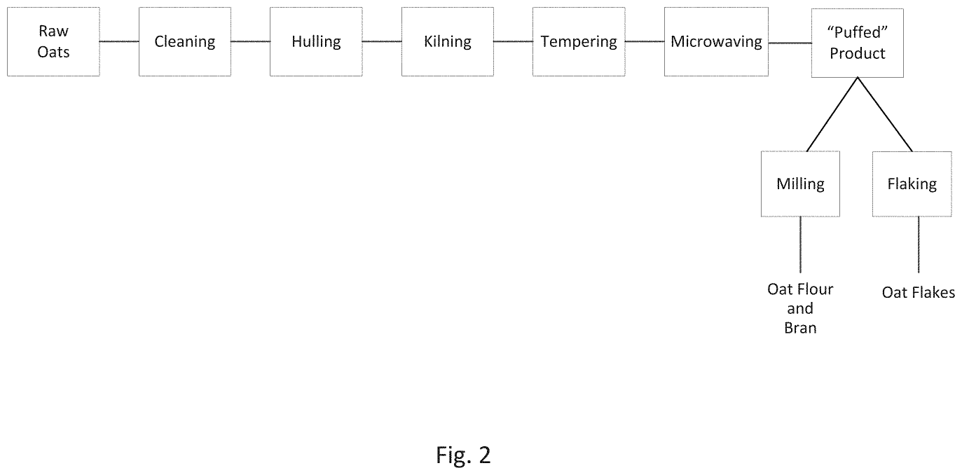

Turning now to FIG. 2, an alternative process is shown for increasing the accessibility of higher molecular weight beta-glucan, with a resulting increase in the viscosity of beta-glucan. This process is identical to that shown and described above in connection with FIG. 1, except that after kilning 40 and before microwaving 60, the groats are tempered 50 to increase their moisture content.

Tempering is performed to increase the moisture content of the groats to greater than about 12 wt. %. Tempering can be accomplished in any known manner such as by subjecting the groats to water in some manner. The groats are tempered to provide a moisture content in the range of about 15 wt. % to about 25 wt. % or from about 15% to about 20%, or about 15% or in some instances about 20%. In some embodiments, the groats are tempered to provide a moisture content of about 13%, about 14%, about 15%, about 16%, about 17%, about 18%, about 19% or about 20%.

In accordance with the above description of the system and process, the following examples are presented to illustrate an exemplary application of the described system and process and are not meant to limit the claimed invention.

### Example 1

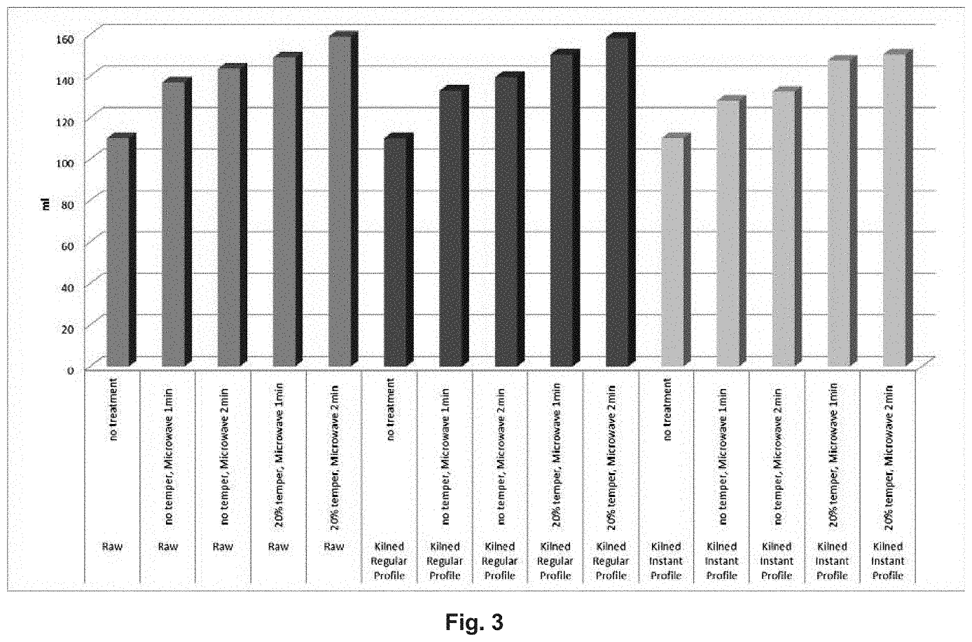

An 80 gram sample of raw oats and kilned oats (regular profile and instant profile) were introduced into a graduated cylinder to determine their initial volume. The results are shown in FIG. 3.

Thereafter, the samples were placed in a covered round glass dish (dimensions: top circumference 12 cm, bottom circumference 10 cm, height 6 cm) and microwaved on HIGH power in a domestic microwave unit (Sharp, Model R-311C (w) C; output 1000 watts) for 30 seconds, 1 minute, or 2 minutes. The microwave treated samples were introduced into a graduated cylinder to determine the volume of 80 grams of the microwave treated groats. The results are shown in FIG. 3.

The raw oats and the kilned oats (regular profile and instant profile) were tempered by adding water to increase the groat moisture content to 15%, 20%, and 25% moisture content. The tempered samples were placed in a covered round glass dish (dimensions: top circumference 12 cm, bottom circumference 10 cm, height 6 cm) and microwaved on HIGH power in a domestic microwave unit (Sharp, Model R-311C (w) C; output 1000 watts) for 30 seconds, 1 minute, or 2 minutes. The results are shown in FIG. 3.

### Example 2

The RVA viscosity of samples of raw oats and kilned oats (regular profile and instant profile) that (1) were not tempered and not microwaved, (2) were not tempered and were microwaved, and (3) were tempered and were microwaved was measured according to the method described above. The results are shown in Table 1.

The apparent viscosity of samples of raw oats and kilned oats (regular profile and instant profile) that (1) were not tempered and not microwaved, (2) were not tempered and were microwaved, and (3) were tempered and were microwaved was measured using a controlled strain rheometer according to the method described above. The results are shown in Table 1.

It was observed that raw groats had low beta-glucan viscosity, consistent with incomplete inactivation of beta-glucanase activity, although microwaving raw groats tempered to 20% moisture did provide some increase in viscosity. In general, for the kilned groats, tempering to higher moisture content and microwave processing provided a positive effect on increasing beta-glucan viscosity; however, increasing the microwave time from one to two minutes did not produce a further increase in viscosity.

TABLE 1
Effect of groat type and processing treatment on beta-glucan extract viscosity in oat groats

| | Tempering | Microwave | RVA Final Viscosity, cP | | | Rheometer @ Visc @ 30/s, | | |
|---|---|---|---|---|---|---|---|---|
| Groat Type | Treatment | Processing Time | Rep 1 | Rep 2 | AVG | Rep 1 | Rep 2 | AVG |
| Raw | no temper | None | 3 | 49 | 26 | 8 | 8 | 8 |
| Raw | no temper | 1 minute | 0 | 4 | 2 | 11 | 11 | 11 |
| Raw | no temper | 2 minutes | 58 | 53 | 56 | 16 | 15 | 15 |
| Raw | 20% temper | 1 minute | 212 | 163 | 188 | 67 | 48 | 58 |
| Raw | 20% temper | 2 minutes | 532 | 533 | 533 | 209 | 210 | 209 |
| Kilned Regular Profile | no temper | None | 478 | 455 | 467 | 250 | 251 | 251 |
| Kilned Regular Profile | no temper | 1 minute | 516 | 583 | 550 | 318 | 377 | 347 |
| Kilned Regular Profile | no temper | 2 minutes | 195 | 284 | 240 | 95 | 140 | 117 |
| Kilned Regular Profile | 15% temper | 30 seconds | 809 | 837 | 823 | 471 | 483 | 477 |
| Kilned Regular Profile | 15% temper | 1 minute | 608 | 701 | 655 | 390 | 391 | 391 |
| Kilned Regular Profile | 15% temper | 2 minutes | 493 | 465 | 479 | 278 | 239 | 258 |
| Kilned Regular Profile | 20% temper | 30 seconds | 663 | 813 | 738 | 384 | 453 | 418 |
| Kilned Regular Profile | 20% temper | 1 minute | 751 | 876 | 814 | 429 | 546 | 488 |
| Kilned Regular Profile | 20% temper | 2 minutes | 702 | 777 | 740 | 438 | 502 | 470 |
| Kilned Regular Profile | 25% temper | 30 seconds | 816 | 962 | 889 | 435 | 474 | 455 |
| Kilned Regular Profile | 25% temper | 1 minute | 1115 | 1304 | 1210 | 568 | 684 | 626 |
| Kilned Regular Profile | 25% temper | 2 minutes | 823 | 837 | 830 | 450 | 480 | 465 |
| Kilned Instant Profile | no temper | None | 323 | 420 | 372 | 184 | 196 | 190 |
| Kilned Instant Profile | no temper | 1 minute | 448 | 474 | 461 | 204 | 201 | 202 |
| Kilned Instant Profile | no temper | 2 minutes | 174 | 206 | 190 | 69 | 79 | 74 |
| Kilned Instant Profile | 20% temper | 1 minute | 975 | 896 | 936 | 560 | 501 | 531 |
| Kilned Instant Profile | 20% temper | 2 minutes | 661 | 685 | 673 | 364 | 399 | 381 |

### Example 3

The average molecular weight of samples of raw oats and kilned oats (regular profile and instant profile) that (1) were not tempered and not microwaved, (2) were not tempered and were microwaved, and (3) were tempered and were microwaved was measured according to the previously described method. The results are shown in Table 2.

TABLE 2
Effect of groat type and processing treatment on beta-glucan solubility and molecular weight in oat groats

| | | | Rep 1 | | Rep 2 | | Average | |
|---|---|---|---|---|---|---|---|---|
| | | Processing | Molecular Weight, | | Molecular Weight, | | Molecular Weight, | |
| Groat | Tempering | Microwave | g/mol | | g/mol | | g/mol | |
| Type | Treatment | Time | Mp | Mw | Mp | Mw | Mp | Mw |
| Raw | no temper | none | 71,330 | 80,090 | 56,931 | 70,780 | 64,130 | 75,435 |
| Raw | no temper | 1 minute | 162,460 | 134,893 | 129,293 | 156,437 | 145,877 | 170,665 |
| Raw | no temper | 2 minutes | 221,913 | 283,057 | 195,897 | 248,900 | 208,905 | 265,978 |
| Raw | 20% temper | 1 minute | 505,380 | 587,923 | 408,090 | 501,297 | 456,735 | 544,610 |
| Raw | 20% temper | 2 minutes | 810,920 | 880,763 | 951,460 | 977,133 | 881,190 | 928,948 |
| Kilned Regular Profile | no temper | none | 985,320 | 1,181,700 | 1,217,367 | 1,345,767 | 1,101,343 | 1,263,733 |
| Kilned Regular Profile | no temper | 1 minute | 1,273,867 | 1,473,633 | 1,735,400 | 1,816,367 | 1,504,633 | 1,645,000 |
| Kilned Regular Profile | no temper | 2 minutes | 1,144,133 | 1,192,967 | 1,460,867 | 1,522,867 | 1,302,500 | 1,357,917 |
| Kilned Regular Profile | 15% temper | 30 seconds | 1,734,900 | 1,788,667 | 1,954,000 | 1,909,267 | 1,844,450 | 1,848,967 |
| Kilned Regular Profile | 15% temper | 1 minute | 1,510,467 | 1,611,767 | 1,826,033 | 1,786,933 | 1,668,250 | 1,668,350 |
| Kilned Regular Profile | 15% temper | 2 minutes | 1,641,267 | 1,692,167 | 1,911,833 | 1,841,200 | 1,776,550 | 1,766,683 |
| Kilned Regular Profile | 20% temper | 30 seconds | 1,783,067 | 1,838,133 | 2,084,733 | 2,090,700 | 1,933,900 | 1,964,417 |
| Kilned Regular Profile | 20% temper | 1 minute | 1,805,367 | 1,648,700 | 2,424,267 | 2,032,933 | 2,114,817 | 1,840,817 |
| Kilned Regular Profile | 20% temper | 2 minutes | 2,121,600 | 2,016,200 | 2,434,367 | 1,963,033 | 2,277,983 | 1,989,617 |
| Kilned Regular Profile | 25% temper | 30 seconds | 2,554,267 | 2,249,133 | 2,130,133 | 2,082,133 | 2,342,200 | 2,165,633 |
| Kilned Regular Profile | 25% temper | 1 minute | 2,454,300 | 2,223,533 | 2,355,133 | 2,150,600 | 2,404,717 | 2,187,067 |
| Kilned Regular Profile | 25% temper | 2 minutes | 2,636,767 | 2,205,567 | 2,220,267 | 2,010,900 | 2,428,517 | 2,108,233 |
| Kilned Instant Profile | no temper | none | 659,077 | 827,483 | 1,044,447 | 1,121,467 | 851,762 | 974,475 |
| Kilned Instant Profile | no temper | 1 minute | 577,683 | 782,493 | 1,038,367 | 1,037,600 | 808,025 | 910,047 |
| Kilned Instant Profile | no temper | 2 minutes | 989,413 | 983,597 | 971,760 | 1,000,867 | 980,587 | 992,232 |
| Kilned Instant Profile | 20% temper | 1 minute | 1,378,067 | 1,484,900 | 1,623,733 | 1,637,533 | 1,500,900 | 1,561,217 |
| Kilned Instant Profile | 20% temper | 2 minutes | 1,372,600 | 1,471,600 | 1,407,133 | 1,492,633 | 1,389,867 | 1,482,117 |

*Mp refers to the peak molecular weight
Mw refers to the weight average molecular weight

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

1. A method for increasing the accessibility of higher molecular weight beta-glucan comprising:
providing groats;
kilning the groats;
subsequently, microwaving the kilned groats at a power and for a period of time to increase the volume of the kilned groats by an amount from about 5% to about 50% and to provide a weight average molecular weight of the beta-glucan of at least 600 kDa.

2. The method of claim 1 wherein the viscosity of the beta-glucan after microwaving is greater than about 500 cP as measured by Rapid Visco Analyzer.

3. The method of claim 1 wherein the kilning is conducted at a temperature and for a time sufficient to achieve a moisture content in the oat groats of about 8 wt. % to about 12 wt. %.

4. The method of claim 1 wherein the microwaving comprises subjecting the kilned groats to microwave power in the range of about 1 kilowatts (kW) to about 1000 kW for a period of time ranging from about 5 seconds to about 300 seconds.

5. The method of claim 1 further comprising tempering the kilned oat groats before microwaving.

6. The method of claim 5 wherein the tempering is conducted for a period of time to achieve a moisture content in the tempered oat groats within a range of about 15 wt. % to about 25 wt. %.
